(19) United States
(12) Patent Application Publication
(10) Pub. No.: US 2010/0310813 A1
(43) Pub. Date: Dec. 9, 2010

(54) LOOP-BACKED CARPET TILES AND METHODS OF MANUFACTURE

(75) Inventor: Shawn David McGill, Dalton, GA (US)

Correspondence Address: SUTHERLAND ASBILL & BRENNAN LLP, 999 PEACHTREE STREET, N.E., ATLANTA, GA, 30309, US

(73) Assignee: BEAULIEU GROUP, LLC, Dalton, GA (US)

(21) Appl. No.: 12/795,626

(22) Filed: Jun. 7, 2010

Related U.S. Application Data
(60) Provisional application No. 61/184,633, filed on Jun. 5, 2009.

(51) Int. Cl. B32B 33/00; B32B 37/12

(52) U.S. Cl. 428/96; 156/310

(57) ABSTRACT

Loop backed carpet tiles and methods of producing a carpet tile having a loop backing are provided. In one embodiment, the method includes applying a precoat adhesive, such as a latex, to the base of a carpet substrate; curing the precoat adhesive onto the carpet substrate; applying a lamination adhesive, which may be an ethyl vinyl acetate or a styrene-acrylate adhesive, onto the precoated carpet substrate, the lamination adhesive having an activation temperature at which the lamination adhesive is operable for lamination; and applying and laminating a backing fabric comprising loops to the precoated carpet substrate via the lamination adhesive after the lamination adhesive applied to the precoated carpet substrate is heated to the activation temperature.

### CROSS-REFERENCE TO RELATED APPLICATIONS

This application claims priority benefit of U.S. provisional patent application No. 61/184,633, filed Jun. 5, 2009. That application is incorporated herein by reference in its entirety.

### FIELD

This disclosure relates generally to the field of carpets and carpet tiles, and more particularly to carpet tiles and methods of manufacturing a carpet tile with loop backing for use with a hook-and-loop installation system.

### BACKGROUND

Carpet tiles are modular floor coverings having a textile top surface which are arranged and installed on various types of floor surfaces. Hook-and-loop installation systems have been developed for removably attaching loop-backed carpet tile to floor surfaces with corresponding hooks. In such installation systems, strips of material comprising hooks are typically attached to portions of a floor surface via adhesive or with mechanical fasteners, and the carpet tiles are then placed on the floor surface on top of the hook strips. The loop backing interlocks with the hooks and holds the carpet tile in place on the floor surface. When one wishes to replace the carpet tile, the carpet tile is simply peeled away from the floor surface, leaving the hook strips attached to the flooring surface.

It would be desirable to provide new and improved methods of manufacturing carpet tile having a loop backing, as well as new carpet tiles having a loop backing. It further would be desired that the manufacturing methods be economically efficient. In addition, it would be desirable to provide carpet tiles, such as ones produced by an improved method, that are lightweight and have good dimensional stability and structural integrity.

### SUMMARY

In one aspect, methods are provided for manufacturing a carpet tile having a loop backing. In one embodiment, the method includes: (i) applying a precoat adhesive to the base of a carpet substrate; (ii) curing the precoat adhesive onto the carpet substrate; (iii) applying a lamination adhesive onto the precoated carpet substrate; and (iv) applying and laminating a backing fabric comprising loops to the precoated carpet substrate via the lamination adhesive after the lamination adhesive applied to the precoated carpet substrate is heated to its activation temperature. In one embodiment, the method includes: (i) applying a precoat of latex to a carpet substrate, and (ii) laminating a loop covered secondary fabric to the latex precoated carpet substrate with a frothed ethyl vinyl acetate adhesive compound.

In another aspect, carpet tile products are provided. The carpet tile may be made by a process described herein. In one embodiment, the carpet tile includes a precoated fabric face having a layer of latex coating cured thereonto, and a loop-covered secondary fabric affixed to the layer of latex coating via a lamination adhesive.

### BRIEF DESCRIPTION OF THE DRAWINGS

FIG. 1 is a process flow diagram illustrating a method for making a loop-backed carpet tile in accordance with one or more embodiments of the present invention.

FIG. 2 is a cross-sectional view of a loop-backed carpet tile in accordance with one or more embodiments of the present invention.

### DETAILED DESCRIPTION

Improved methods of manufacturing carpet tile have been developed, along with improved carpet tile products. The carpet tile includes a loop backing for use with hook-and-loop installation systems.

### I. Methods of Manufacturing Carpet Tile

In one aspect, a method of manufacturing a carpet tile having a loop backing is provided.

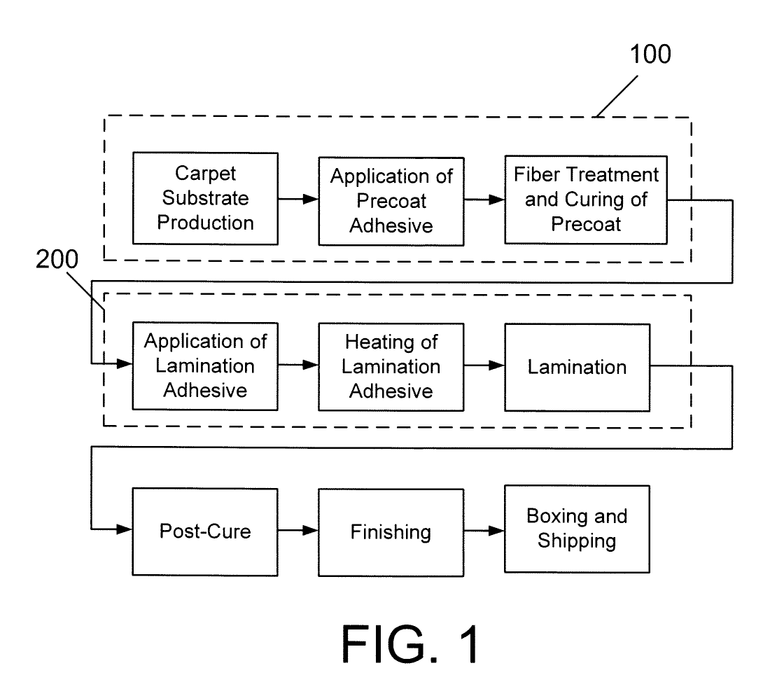

As illustrated in FIG. 1, the carpet tiles may be produced by a method involving two separate in-line processes 100, 200. In in-line process 100, a carpet substrate, or fabric face, may be first produced, for example by a broadloom or fusion-bonding process known in the art. The base of the carpet substrate may then be coated with a layer of a precoat adhesive, such as a latex. The fibers of the carpet substrate may be treated with one or more additives known in the art. Representative examples of suitable additives include color-fastness additives, bleach resistance additives, antimicrobial treatments, odor eliminating treatments, and the like. The fiber treatment can be done at various steps in the process, including before, during, or after the precoat process, but before lamination of the loop secondary. After the precoat step, the precoat is cured, or annealed, for example by passing the carpet through a drying oven. In one embodiment, the fiber treatment is done as part of the precoat step in order to take advantage of the heat of the precoat oven to anneal fiber treatments. That is, for example, the heating in the oven simultaneously achieves both fiber treatment annealing and precoat curing. This heating, however, advantageously is done before lamination of the loop secondary, so as to avoid or reduce heat damage that can harm the structure and/or diminish the functionality of the loop backing. In a preferred embodiment, the carpet substrate and precoat adhesive subsequently are cured together, for example, by passing the precoated carpet substrate through a drying oven.

In one embodiment, between in-line process 100 and in-line process 200 separate tufting runs, i.e., individual rolls of the precoated carpet substrate are sewn together to create a continuous flow of carpeting for use in in-line process 200. This may be done as designated by scheduling. The sewing may be a separate process, which may be offline with respect to in-line process 100 and in-line process 200.

In one embodiment, a secondary fabric that includes loops for a hook-and-loop installation system may be produced or otherwise obtained for use in process 200. The production of the secondary fabric may be a separate process, or it may integrated, e.g., fed directly, into process 200.

In a preferred embodiment of in-line process 200, a lamination adhesive is applied to the base of the carpet substrate. In a particular embodiment, the lamination adhesive is applied directly to the layer of cured precoat adhesive. In a preferred embodiment, the lamination adhesive formed into a frothed adhesive composition before application to the layer of cured precoat adhesive.

In one embodiment, after the lamination adhesive is applied to the carpet substrate, the precoated carpet substrate and lamination adhesive are heated to the activation temperature of the laminate adhesive. As used herein, the term “activation temperature” refers to the temperature at which the laminate adhesive is suitable (e.g., effective) for laminating a loop secondary fabric to the precoated carpet substrate. For EVA, the activation temperature is approximately 210-230° F. The heating may be carried out by essentially any oven and/or heater means known in the art. In various embodiments, heating is performed using electric convection heat, gas convection heat, infrared heat, hot oil drums, or the like.

Once the laminate adhesive is applied and heated to its activation temperature, the loop covered secondary material may then be applied and laminated to the carpet substrate. In a preferred embodiment, the loop secondary material is applied and laminated using a pressurized lamination roller. In one embodiment, the lamination roller comprises dual large diameter (12″ minimum) non-stick pressurized rolls. In a preferred embodiment, it includes a water-cooled roller. In a preferred embodiment, the lamination roller has pressure settings ranging from 250 to 400 psi to insure lamination and optimal loop performance.

In one embodiment, the loop secondary cannot be exposed to heat in excess of 250° F. The presently disclosed process advantageously enables the product of the carpet structure without exposing the loop secondary to a temperature that could melt and damage the loop structures during the step of attaching (e.g., laminating) the loop secondary to the carpet substrate.

The loop covered secondary fabric is oriented with respect to the carpet substrate such that the loops of the secondary fabric extend in the opposite direction from the fabric face, e.g., the tufts, of the carpet substrate.

Subsequently, the freshly laminated loop backed carpet may then be rolled into appropriate sized rolls for post-curing. In one embodiment, the rolls of carpet are allowed to post-cure for at least 18 hours. In a preferred embodiment, the post-cured carpet is then unrolled and cut into individual carpet tiles. The tiles may be then finished with bevels and/or singed, and then may be boxed for storage or shipment.

In one embodiment, the method includes: (i) applying a precoat adhesive to the base of a carpet substrate; (ii) curing the precoat adhesive onto the carpet substrate; (iii) applying a lamination adhesive onto the precoated carpet substrate; and (iv) applying and laminating a backing fabric comprising loops to the precoated carpet substrate via the lamination adhesive after the lamination adhesive applied to the precoated carpet substrate is heated to its activation temperature.

In one embodiment, the method includes: (i) applying a precoat of latex to a carpet substrate, and (ii) laminating a loop covered secondary fabric to the latex precoated carpet substrate with a frothed ethyl vinyl acetate (EVA) adhesive compound.

### Carpet Substrate

The carpet substrate or fabric face may comprise any type of fabric face suitable for use in carpeting or carpet tile applications. The carpet substrate typically is formed of a primary carpet base having tufts created by sewing a yarn through the primary carpet base. Various types of fabric face are commonly used including cut pile, loop pile, cut and loop pile, tufted, bonded, woven, nonwoven, or the like. Various methods are known for producing carpet substrate including conventional broadloom tufting and/or fusion bonding techniques.

### Precoating the Carpet Substrate

An adhesive may be applied as a precoating to the carpet substrate to maintain the integrity of the fabric face. Once cured, the precoat adhesive preserves the structural integrity of the fabric face and provides dimensional stability to the carpet substrate. The adhesive also provides a mechanism for attaching other materials to the base of the fabric face.

A variety of adhesive materials may be suitable as the precoat adhesive, such as curable latex, urethane or vinyl systems. Representative examples include polyethylene terephthalate (PET), polytrimethylene terephthalate (PTT), hotmelt, ethylene vinyl acetate (EVA), latexes, styrene butadiene rubber (SBR), polyolefin, polyurethane, or a combination thereof. The precoat adhesive may include fillers and/or other ingredients. The precoat adhesive is selected to provide suitable dimensional stability, dry and wet strength, elongation, and tear strength to the carpet tile product. The amount of precoat adhesive used to form the precoat layer may vary, for example, from about 15 to 30 ounces (dry weight) per square yard.

In one embodiment, the fabric face is precoated on its base with a layer of a latex polymer. In one case, 24 to 30 ounces (dry weight) per square yard of latex is applied to the base of the carpet substrate to form a layer of latex, or a latex coating. In a preferred embodiment, the fabric face is precoated on its base with a layer of a SBR. In certain embodiments, 16 to 28 ounces (dry weight) per square yard of SBR is applied to the base of the carpet substrate to form a layer of SBR precoat.

The precoat adhesive may be applied to the carpet substrate by any of a number of known methods, including, but not limited to, application by a pan applicator using a roller, a roll over a roller or a bed, or a knife (also called a doctor blade) over a roller bed.

Once the precoat adhesive is applied to the carpet substrate, the precoated carpet substrate may be passed through a drying oven to cure the precoat adhesive onto the fabric face. In one embodiment, where the precoat comprises a latex, the precoated carpet substrate is fed through drying oven at a temperature of approximately 350 to 375° F. It is also envisioned that the precoat adhesive may be dried or cured by other known techniques and equipment.

### Loop Covered Secondary Fabric

Loop-covered fabrics are commonly used in hook-and-loop fastening systems. Accordingly, various methods are known for making loop-covered fabrics. In an exemplary method, a nonwoven fabric material is subjected to a needle punching which results in the formation of loops in an irregular pattern.

Preferred embodiments of the present methods and articles utilized a backing fabric comprising loops that are effective for use with various hook-and-loop installation systems for carpet tiles. This loop-covered secondary fabric, or loop secondary, may comprise various materials including, but not limited to, polypropylene, cotton, polyester, and/or nylon.

In a preferred embodiment, the loop covered secondary is a polyethylene teraphthalate (PET) and polypropylene (PP) composite. In a particular case, the composite has a total weight from 110 to 150 grams per square yard.

### Lamination Adhesive and Lamination

The loop-covered secondary fabric may be laminated to the precoated carpet substrate using various lamination adhesives. In one embodiment, the adhesive comprises ethylene vinyl acetate (EVA) or a styrene-acrylate based polymer. In other embodiments, various polymer adhesives may be used, including but not limited to polyvinyl chlorides (PVC), modified polypropylenes, modified polyethyleneterephthalates (PET), and copolymers and blends thereof. The adhesive composition optionally may further include various components, such as fillers and/or stabilizing materials. Such additives are known in the art.

In some embodiments, a frothed adhesive is used. The term “frothed”, as used herein, generally refers adhesive materials in which a gas, such as air, has been incorporated into the adhesive, e.g., as tiny bubbles dispersed therein, to give the lamination adhesive a foam-like consistency. When a frothed adhesive is used, less mass of the lamination adhesive is required to produce the desired adhesive depth. There are many ways to produce a frothed adhesive. For example, the foam may be mechanically agitated to incorporate air into the liquid adhesive. Alternatively, a gas may be blown or sparged into the liquid adhesive.

In some embodiments, the adhesive is applied directly to the precoated carpet substrate to form the lamination adhesive layer. The amount may vary, for example, from about 2 to about 5 ounces (dry weight) per square yard. In a preferred embodiment, the frothed adhesive composition includes ethylene vinyl acetate (EVA). In a preferred embodiment, the frothed adhesive composition includes a styrene-acrylate based polymer. In one embodiment, about 3 to 5 ounces (dry weight) of frothed EVA is applied to the precoated carpet substrate per square yard. In one embodiment, about 2 to 5 ounces (dry weight) of frothed styrene-acrylate based polymer is applied to the precoated carpet substrate per square yard.

The carpet and lamination adhesive are heated to the activation temperature of the lamination adhesive prior to lamination. In one embodiment, the activation temperature is from about 210° F. to about 230° F. It should be noted that different temperature ranges and/or adhesive amounts may be required if different adhesives are used. After the adhesive is applied to the precoated carpet substrate and the lamination adhesive is heated to its activation temperature, the loop-covered secondary fabric is laminated onto the adhesive material. In a preferred embodiment, this is done via a pressurized lamination roller. The loop-covered secondary fabric is arranged with respect to the precoated carpet substrate such that the loops of the secondary fabric extend in the opposite direction of the tufts of the fabric face. In some embodiments, the pressurized lamination roller is configured to apply between 300 to 600 psi of pressure.

By applying the lamination adhesive to the precoated carpet substrate and heating the lamination adhesive and carpet substrate prior to lamination with the loop-covered secondary fabric, the structural integrity of the loops of the secondary fabric is better preserved. This is particularly true for secondary fabrics which comprise polypropylene, since narrow strands of polypropylene have the tendency to melt if exposed to elevated temperatures for even a short period of time. Accordingly, in some embodiments, the loop-covered secondary fabric is not directly exposed to the heat source used to heat the lamination adhesive to its activation temperature.

### II. Looped-Back Carpet Tile Products, Systems, and Methods of Use

In another aspect, carpet tile products are provided, which may be produced by the foregoing methods. The carpet tile products may be used with various hook-and-loop installation systems.

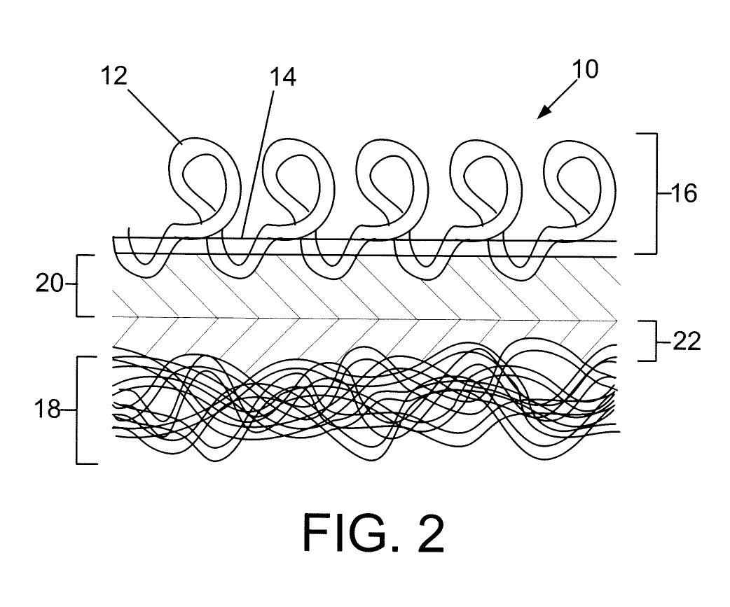

One embodiment of a carpet tile produced by the foregoing methods is illustrated in FIG. 2. The carpet tile product 10 generally includes a carpet substrate 16 having a layer of precoat adhesive 20 laminated to a loop-covered secondary fabric 18 via a lamination adhesive 22. The carpet substrate 16 is generally formed of a yarn 12 sewn through a primary backing layer 14. Although a “loop” type tuft is illustrated, various types of fabric faces may be manufactured using known broadloom and fusion bonding techniques. The carpet substrate 16 further includes a cured precoat adhesive layer 20. In some embodiments, the precoat adhesive 20 comprises latex.

The loop-covered secondary fabric 18 is laminated to the base of the carpet substrate 16 (i.e., to the precoat adhesive layer 20) via a lamination adhesive 22. In some embodiments, the loop-covered secondary fabric 18 may comprise polypropylene. In other embodiments, however, the loop-covered secondary fabric 18 may comprise cotton, nylon, and/or polyester. Various adhesives may be used for the lamination adhesive 22 including ethylene vinyl acetate. In some embodiments, the lamination adhesive has an activation temperature in the range of about 210 to about 240° F. In certain embodiments, the lamination adhesive 22 may comprise a frothed adhesive. That is, frothed air bubbles may or may not be present after lamination, depending for example on the breathability/barrier properties that are desired for the finished loop tile product.

The carpet tile product 10 of FIG. 2 generally requires no additional stabilizing materials to provide dimensional stability (i.e., resistance to shrinking, growth, or curling); however, additional stabilizing materials such as fiberglass scrim may also be integrated in to the product 10 if needed.

The carpet tiles may be of any desired geometry and area dimension. A preferred shape is that of a square tile. Particularly preferred are square tiles which are 18″ by 18″, 24″ by 24″, 36″ by 36″, 50 cm by 50 cm, or 1 m by 1 m. Tiles having other dimensions and other shapes are also contemplated. The carpet tiles also may be of any desired thickness. For example, the carpet tiles may have an overall thickness from about 0.15″ to about 0.75″.

In one embodiment, a carpet tile product includes a precoated fabric face having a layer of latex coating cured thereonto, and a loop-covered secondary fabric affixed to the layer of latex coating via a lamination adhesive. In a preferred version of this embodiment, the lamination adhesive comprises EVA.

The carpet tiles described herein may be used with essentially any installation system for floor and wall surface coverings. For example, using the loops on the underside of the carpet tiles, one may affix the carpet tiles to essentially any floor, or subfloor/wall system, which is provided with the complementary hooks for engaging with the loops.

Modifications and variations of the methods, products, and systems described herein will be obvious to those skilled in the art from the foregoing detailed description. Such modifications and variations are intended to come within the scope of the appended claims.

I claim:

1. A method of producing a carpet tile having a loop backing comprising:
applying a precoat adhesive to the base of a carpet substrate;
curing the precoat adhesive onto the carpet substrate;
applying a lamination adhesive onto the precoated carpet substrate, the lamination adhesive having an activation temperature at which the lamination adhesive is operable for lamination; and
applying and laminating a backing fabric comprising loops to the precoated carpet substrate via the lamination adhesive after the lamination adhesive applied to the precoated carpet substrate is heated to the activation temperature.

2. The method of claim 1, wherein the precoat adhesive comprises a latex.

3. The method of claim 1, wherein the lamination adhesive comprises a frothed adhesive.

4. The method of claim 1, wherein the lamination adhesive comprises ethylene vinyl acetate or a styrene-acrylate polymer.

5. The method of claim 3, wherein the lamination adhesive comprises ethylene vinyl acetate or a styrene-acrylate polymer.

6. The method of claim 1, wherein the activation temperature is in the range of about 210° F. to about 230° F.

7. The method of claim 1, wherein lamination adhesive is heated after the lamination adhesive is applied to the precoated carpet substrate.

8. The method of claim 7, wherein the backing fabric is not directly exposed to a source of heat used to heat the lamination adhesive to its activation temperature.

9. The method of claim 1, wherein the backing fabric comprises polypropylene.

10. The method of claim 1, wherein the lamination comprises using a pressurized lamination roller.

11. A method of producing a carpet tile having a looped backing comprising:
applying a precoat of latex to a carpet substrate; and
laminating a loop covered secondary fabric to the latex precoated carpet substrate with an adhesive compound which comprises ethyl vinyl acetate or a styrene-acrylate polymer.

12. The method of claim 11, wherein the adhesive compound is frothed.

13. A carpet tile made by the method of claim 1.

14. A carpet tile made by the method of claim 11.

15. A carpet tile product comprising:
a fabric face having a layer of latex coating cured thereonto; and
a loop-covered secondary fabric affixed to the layer of latex coating via a lamination adhesive.

16. The carpet tile product of claim 15, wherein the lamination adhesive comprises ethyl vinyl acetate or a styrene-acrylate polymer.
